(19) United States
(12) Patent Application Publication
(10) Pub. No.: US 2016/0109750 A1
(43) Pub. Date: Apr. 21, 2016

(54) LIQUID CRYSTAL DISPLAY

(71) Applicant: Samsung Display Co., LTD., Yongin-City (KR)

(72) Inventors: Joong Tae KIM, Icheon-si (KR); In Woo KIM, Asan-si (KR); Kwang su PARK, Yongin-si (KR); Da Young LEE, Seoul (KR); Yong Tae CHO, Cheonan-si (KR); Min Ha HWAHG, Seoul (KR)

(21) Appl. No.: 14/681,514

(22) Filed: Apr. 8, 2015

(30) Foreign Application Priority Data
Oct. 21, 2014 (KR) 10-2014-0142530

(51) Int. Cl. G02F 1/1335; G02F 1/1343; G02F 1/1362

(52) U.S. Cl. CPC G02F 1/133514; G02F 1/133512; G02F 1/136286; G02F 1/134336; G02F 2001/133519

(57) ABSTRACT

A liquid crystal display device according to the present invention includes: a first substrate; a first color filter and a second color filter provided on the first substrate and including an overlapping portion where at least parts of the first and second color filters overlap each other; and a light blocking member formed between the first substrate and the overlapping portion, wherein the light blocking member includes a recessed portion corresponding to the overlapping portion of the first color filter and the second color filter. According to the present invention, the recessed portion is formed in the light blocking member provided in the overlapping portion of two or more color filters to reduce a step difference caused by the overlapping portion of the color filters, thereby preventing an alignment defect.

### CLAIM OF PRIORITY

This application claims the priority to and all the benefits accruing from 35 U.S.C. §119 of Korean Patent Application No. 10-2014-0142530 filed in the Korean Intellectual Property Office (“KIPO”) on Oct. 21, 2014, the entire contents of which are incorporated herein by reference.

### BACKGROUND OF THE INVENTION

1. Field of the Invention

The present invention relates to a liquid crystal display.

2. Description of the Related Art

A liquid crystal display, which is one of the most common types of flat panel displays currently in use, includes two sheets of display panels with field generating electrodes such as a pixel electrode, a common electrode, and the like, and a liquid crystal layer interposed therebetween. The liquid crystal display device generates an electric field in the liquid crystal layer by applying a voltage to the field generating electrodes, determines alignment of liquid crystal molecules of the liquid crystal layer through the generated electric field, and controls polarization of incident light, thereby displaying images.

The liquid crystal display device includes a switching element connected to each pixel electrode, and a plurality of signal lines such as a gate line and a data line for applying a voltage to the pixel electrode by controlling the switching element.

In general, the liquid crystal display device displays an image with a combination of colors displayed through color filters of different colors formed in a plurality of pixels, and displays a desired image by properly controlling luminance of each pixel.

The foregoing information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a liquid crystal display device that can solve problems such as generation of a horizontal line, reduction of cell gap, and twist of liquid crystal alignment due to generation of a step difference from an increase of a height of an overlapping portion where color filters of neighboring pixels overlap each other.

To enhance pixel areas of display device, the color filters are formed very close to each other. Precision control of the dimensions of the color filter can avoid overlapping but along with an increase of display resolution, each pixel size could be largely reduced, rendering the precision control of the color filters to avoid overlapping extremely difficult. In high resolution display devices, the edge portions of adjacent color filters may overlap each other. The overlapping portions may have a total thickness greater than the thickness of either one of the adjacent color filters. To define each pixel and avoid light being a blend of unintended mixture of colors emitted from the overlapping portions of the color filters, light blocking members may be formed at the overlapping portions of the color filters. Since the thicknesses of the light blocking members have to achieve a certain value in order to maintain proper functioning of the light blocking property, the thickness of the light blocking member may add to the total thickness of the overlapping portions and the significantly increased thickness cannot be planarized by a planarization layer, thus causing a significantly reduced cell gap along with misalignment of electrodes and liquid crystals located between the misaligned electrodes. A device is sought that can remove the reduction of cell gap while allowing the above situation of adjacent color filters to overlap each other at the edges and can avoid the complexity of precision control of the dimension of the formed color filters.

A liquid crystal display device according to an exemplary embodiment of the present invention includes a first substrate; a first color filter and a second color filter provided on the first substrate and including an overlapping portion where at least parts of the first and second color filters overlap each other; and a light blocking member formed between the first substrate and the overlapping portion, wherein the light blocking member includes a recessed portion corresponding to the overlapping portions of the first color filter and the second color filter.

A plurality of pixels may be formed on the first substrate, the plurality of pixels may include gate lines in a row direction and data lines in a column direction, and the recessed portion of the light blocking member may be formed in an area corresponding to the data line.

The liquid crystal display device further includes a third color filter, wherein the overlapping portion may be formed in two color filters selected from the first color filter, the second color filter, and the third color filter.

Each of the first to third color filters may be formed with a color selected from red, green, and blue.

The recessed portion of the light blocking member may be formed in all areas that overlap the overlapping portion.

The liquid crystal display device may further include a passivation layer provided in an upper surface of the color filters and made of an organic insulation material.

The light blocking member may be made of chromium, chromium oxide, or an organic material.

The shape of a cross-section of the recessed portion may be a quadrangle, a triangle, or a semi-circle.

The liquid crystal display device may further include a field generating electrode formed on the first substrate.

A liquid crystal display device according to another exemplary embodiment of the present invention includes a first substrate where a plurality of pixels are formed; a second substrate facing the first substrate; a first color filter and a second color filter provided on the second substrate and including an overlapping portion where at least a part of the first color filter and a part of the second color filter overlap each other; a light blocking member formed between the second substrate and the overlapping portion; and a liquid crystal layer including liquid crystal molecules provided between the first substrate and the second substrate, wherein the light blocking member includes a recessed portion corresponding to the overlapping portion of the first color filter and the second color filter.

According to the present invention, the recessed portion is formed in the light blocking member provided in the overlapping portion of two or more color filters to reduce a step difference caused by the overlapping portion of the color filters, thereby preventing an alignment defect of the liquid crystals.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIGS. 1A and 1B are schematic cross-sectional views of color filters and light blocking members according to an exemplary embodiment FIG. 1A and a comparative example FIG. 1B of the present invention.

FIG. 2 is an equivalent circuit diagram of a pixel of a liquid crystal display device according to an exemplary embodiment of the present invention.

FIG. 3 is a pixel layout view of the liquid crystal display device according to the exemplary embodiment of the present invention.

FIG. 4 is a cross-sectional view of FIG. 3, taken alone the line IV-IV.

FIG. 5 is a pixel layout view of a liquid crystal display device according to another exemplary embodiment of the present invention.

FIG. 6 is a cross-sectional view of FIG. 5, taken along the line VI-VI.

FIG. 7A is a schematic cross-sectional view of a conventional LCD display device that do not have reduced cell gap due to overlapping of the color filters and FIG. 7B is a schematic cross-section view of a conventional LCD display device having reduced cell gap due to overlapping of color filters.

### DETAILED DESCRIPTION OF THE INVENTION

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

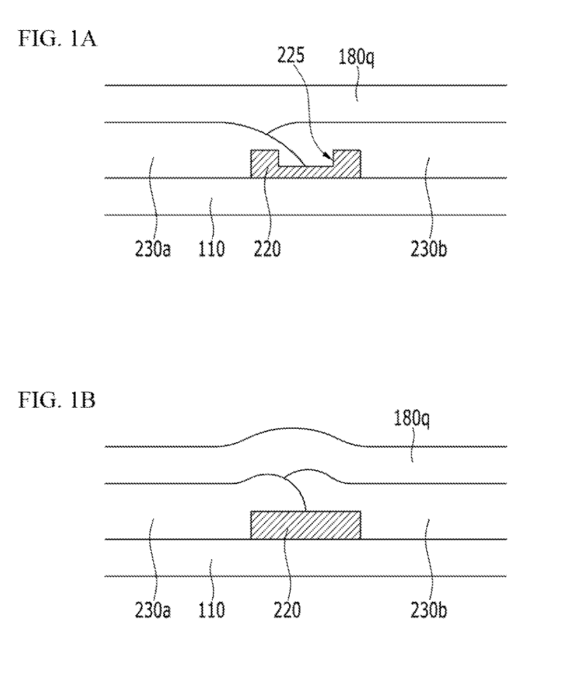

A liquid crystal display device according to an exemplary embodiment of the present invention will be schematically described with reference to FIG. 1A.

FIG. 1A shows an exemplary embodiment of the present invention, and FIG. 1B is a schematic cross-sectional view of a color filter and a light blocking member according to a comparative example of the present invention.

Referring to FIG. 1A, a color filter 230 is formed on an insulation substrate 110 in the liquid crystal display device according to the exemplary embodiment of the present invention. The color filter 230 may include, for example, red, green, and blue color filters, but this is not restrictive. The color filter 230 may be one of color filters of other primary colors of cyan, magenta, yellow, and the like, or may include a white color filter.

In FIG. 1A or 1B, a portion where a first color filter 230a and a second color filter 230b overlap each other is illustrated for convenience of description, but the first color filter 230a and the second color filter 230b, the second color filter 230b and a third color filter (not shown), and the first color filter 230a and the third color filter (not shown) may respectively form overlapping portions.

A light blocking member 220 is formed on the insulation substrate 110 and the light blocking member 220 is disposed in a lower portion of an overlapping portion where the color filters 230a and 230b overlap. The light blocking member 220 may be formed of a single layer or a double layer of chromium and a chromium oxide, or of an organic material.

The light blocking member 220 according to the exemplary embodiment of the present invention includes a recessed portion 225 that is formed at a location corresponding to an overlapping portion where the two color filters 230a and 230b overlap each other.

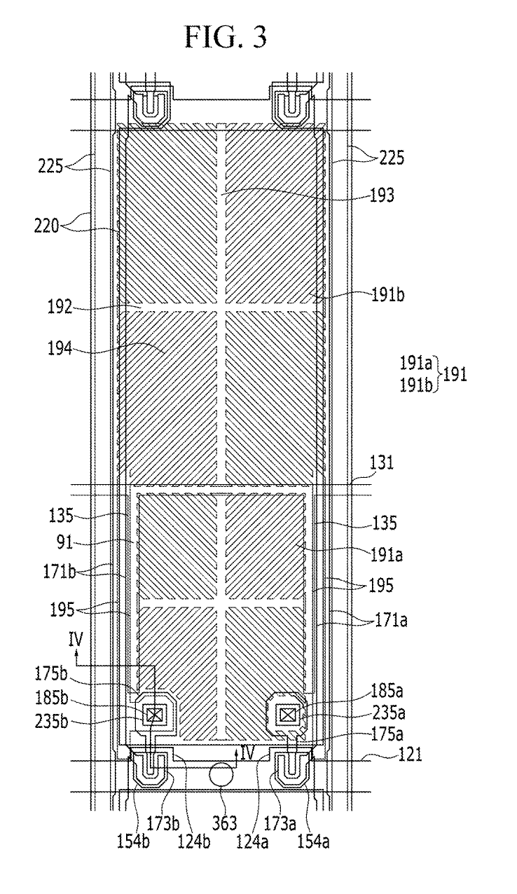

The recessed portion 225 may be formed throughout the overlapping portion along the overlapping portion where the two color filters 230a and 230b overlap. The recessed portion 225 may be formed with a shape of a line so as to overlap a data line area formed at a vertical directional edge of each pixel (FIG. 3).

In general, as shown in FIG. 1B, the overlapping portion where the color filters 230a and 230b overlap each other may have a step at an upper surface due to overlapping of the two color filters 230a and 230b compared to other portions where the color filters 230a and 230b do not overlap each other.

Furthermore, the light blocking member 220 is provided in a lower portion of the overlapped portion of the color filters 230a and 230b so that the step of the overlapping portion of the color filters 230a and 230b may become more significant. In this case, due to the step generated by the overlapping portion of the color filters 230a and 230b, a cell gap of the liquid crystal display device is significantly reduced in the overlapping portion, and accordingly causes a defect in liquid crystal alignment and a defect in display quality.

Thus, in the liquid crystal display device according to the exemplary embodiment of the present invention, the recessed portion 225 is formed in the light blocking member 220 that is disposed in a lower portion of the overlapping portion formed by overlapping the color filters 230a and 230b to reduce a step formed in the overlapping portion of the color filters 230a and 230b, thereby preventing decrease of the cell gap and a liquid crystal alignment defect.

The shape of a cross-section of the recessed portion 225 of the light blocking member 220 is illustrated as a quadrangle for convenience, but the cross-section may have various shapes such as a triangle, a semi-circle, and the like.

An upper passivation layer 180q made of a transparent organic insulating material is formed on the color filters 230a and 230b, and the upper passivation layer 180q prevents the color filters 230a and 230b from being exposed and provides a flat surface.

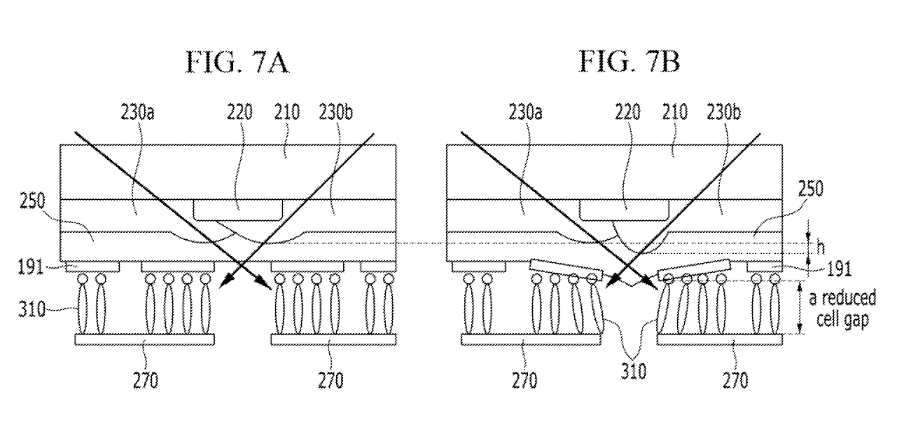

Liquid crystals in the condition of overlapping of color filters shown in FIG. 1B is shown in FIGS. 7A and 7B as the overlapping may not cause a significant reduction of cell gap in FIG. 7A or the overlapping may cause a significant reduction of cell gap shown in FIG. 7B as the cell gap is reduced by an amount of h and the liquid crystals 310 at a region having significantly reduced cell gap are misaligned, thereby causing deterioration in the display's quality.

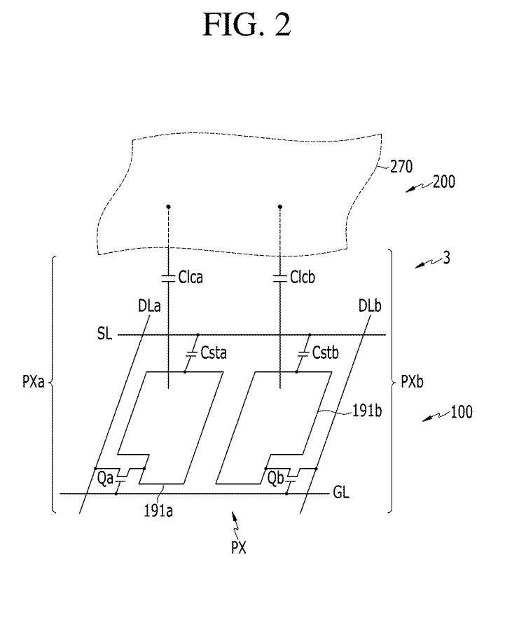

Now, referring to FIGS. 2 to 4, the liquid crystal display device including the light blocking member according to the exemplary embodiment of the present invention will be described in detail.

However, the exemplary embodiment of the present invention shown in FIG. 2 to FIG. 4 is an example of the liquid crystal display device that can include the light blocking member of the present invention, and it is not restrictive.

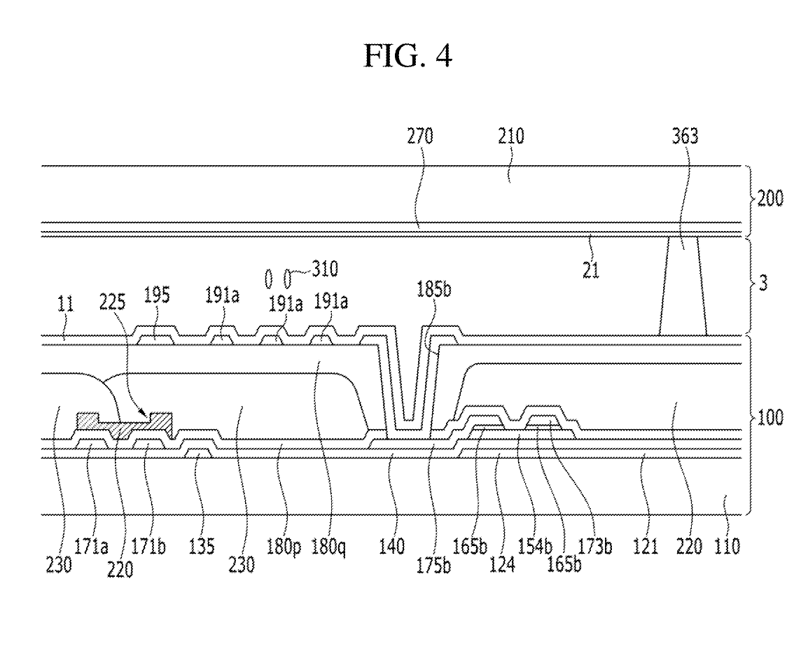

FIG. 2 is an equivalent circuit diagram of a pixel of the liquid crystal display device according to the exemplary embodiment of the present invention, FIG. 3 is a pixel layout view of the liquid crystal display device according to the exemplary embodiment of the present invention, and FIG. 4 is a cross-sectional view of FIG. 3, taken along the line IV-IV.

First, referring to FIG. 2, the liquid crystal display device according to the exemplary embodiment of the present invention includes a thin film transistor array (lower) panel 100, a common electrode (upper) panel 200, and a liquid crystal layer 3 provided between the thin film transistor array panel 100 and the common electrode panel 200.

The liquid crystal display device includes signal lines including a plurality of gate lines GL, a plurality of pairs of data lines DLa and DLb, and a plurality of storage electrode lines SL, and a plurality of pixels PX connected to the signal lines.

Each pixel PX includes a pair of sub-pixels PXa and PXb, and the sub-pixels PXa and PXb include switching elements Qa and Qb, liquid crystal capacitors Clca and Clcb, and storage capacitors Csta and Cstb.

The switching element is a three-terminal element such as a thin film transistor, which is provided in the lower panel 100, and a control terminal thereof is connected with the gate line GL, an input terminal thereof is connected with the data lines DLa and DLb, and an output terminal thereof is connected with the liquid crystal capacitors Clca and Clcb and the storage capacitors Csta and Cstb.

The liquid crystal capacitors Clca and Clcb includes sub-pixel electrodes 191a and 191b and a common electrode 270 as two terminals, and a portion of the liquid crystal layer 3 between the two terminals is formed as a dielectric material.

The storage capacitors Csta and Cstb playing auxiliary roles of the liquid crystal capacitors Clca and Clcb are formed when the storage electrode line SL provided in the lower panel 100 and the sub-pixel electrodes 191a and 191b overlap each other with an insulator therebetween, and a predetermined voltage such as a common voltage Vcom is applied to the storage electrode line SL.

Voltages respectively charged in the two liquid crystal capacitors Clca and Clcb are set to be slightly different from each other. For example, a data voltage applied to one liquid crystal capacitor Clca is set to always be lower or higher than a data voltage applied to the other liquid crystal capacitor Clcb, which is adjacent to the liquid crystal capacitor Clca. An image viewed from a side can be looked similar to an image viewed from a front by appropriately controlling a voltage of the two liquid crystal capacitors Clca and Clcb such that side visibility of the liquid crystal display device can be improved.

Hereinafter, the liquid crystal display device according to the exemplary embodiment of the present invention will be described in further detail with reference to FIGS. 3 and 4.

Referring to FIGS. 3 and 4, the liquid crystal display device according to the exemplary embodiment of the present invention includes the lower panel 100 and the upper panel 200 that face each other, and the liquid crystal layer 3 provided between the two panels 100 and 200.

First, the lower panel 100 will be described.

A plurality of gate lines 121 and a plurality of storage electrode lines 131 and 135 are formed on the insulation substrate 110.

The gate lines 121 transmit a gate signal and substantially extend in a horizontal direction. Each gate line 121 includes a plurality of first and second gate electrodes 124a and 124b that protrude upward.

The storage electrode lines include a stem 131 substantially extending in parallel with the gate line 121 and a plurality of storage electrodes 135 extended from the stem 131. The shape and alignment of the storage electrode lines 131 and 135 may be variously modified.

The gate lines 121 and the storage electrode lines 131 and 135 may be formed of at least one selected from a group consisting of an aluminum-based metal such as aluminum (Al), an aluminum alloy, and the like, a sliver-based metal such as silver (Ag), a sliver alloy, and the like, and a cooper-based metal such as cooper (Cu), a cooper alloy, and the like.

In the present exemplary embodiment, the gate line 121 and the gate electrodes 124a and 124b are formed as single layers, but they may be formed as double layers, triple layers, or the like.

When the gate lines 121 and the gate electrodes 124a and 124b have a dual-film structure, the gate lines 121 and the gate electrodes 124 may be formed by a lower film and an upper film, and the lower film may be formed by at least one selected from one group that is constituted by a molybdenum-based metal such as molybdenum (Mo), a molybdenum alloy, chromium (Cr), a chromium alloy, titanium (Ti), a titanium alloy, tantalum (Ta), a tantalum alloy, manganese (Mn), and a manganese alloy. The upper film may be made of at least one selected from one group that is constituted by an aluminum-based metal such as aluminum (Al) and an aluminum alloy, a silver-based metal such as silver (Ag) and a silver alloy, and a copper-based metal such as copper (Cu) and a copper alloy. In the case of a triple-film structure, films having different physical properties may be adjacent to each other.

A gate insulating layer 140 is formed on the gate line 121 and the storage electrode lines 131 and 135, and a plurality of semiconductors 154a and 154b made of amorphous or crystalline silicon are formed on the gate insulating layer 140.

A plurality of pairs of ohmic contacts 163a and 165b are formed on the respective semiconductors 154a and 154b, and the ohmic contacts 163a and 165b may be made of a silicide or a material such as n+ hydrogenated amorphous silicon in which n-type impurity is doped at a high concentration.

A plurality of pairs of data lines 171a and 171b and a plurality of pairs of first and second drain electrodes 175a and 175b are formed on the ohmic contacts and the gate insulating layer 140.

The data lines 171a and 171b transfer data signals and mainly extend in a vertical direction to cross the gate lines 121 and the stems 131 of the storage electrode lines. The data lines 171a and 171b include first and second source electrodes 173a and 173b which extend toward the first and second gate electrodes 124a and 124b to be curved in a U-letter form, and the first and second source electrodes 173a and 173b face the first and second drain electrodes 175a and 175b based on the first and second gate electrodes 124a and 124b.

The data lines 171a and 171b may be formed with at least one selected from a group consisting of an aluminum-based metal such as aluminum (Al) and an aluminum alloy, a silver-based metal such as silver (Ag) and a silver alloy, and a copper-based metal such as copper (Cu) and a copper alloy. In the exemplary embodiment, the data line 171a and 171b are described to be formed as a single layer, but are not limited thereto, and may be formed as a double layer, a triple layer, or the like.

The first and second drain electrodes 175a and 175b extend upwards from ends which are partially surrounded by the first and second source electrodes 173a and 173b, respectively, and the opposite ends may have a wide area for connection with other layers.

However, shapes and layouts of the data lines 171a and 171b in addition to the first and second drain electrodes 175a and 175b may be variously modified.

The first and second gate electrodes 124a and 124b, the first and second source electrodes 173a and 173b, and the first and second drain electrodes 175a and 175b form first and second thin film transistors (TFTs) Qa and Qb together with the first and second semiconductors 154a and 154b, respectively, and channels of the first and second thin film transistors Qa and Qb are formed in the first and second semiconductors 154a and 154b between the first and second source electrodes 173a and 173b and the first and second drain electrodes 175a and 175b.

The ohmic contacts 163a and 163b exist only among the semiconductors 154a and 154b therebelow, the data lines 171a and 171b thereabove, and the drain electrodes 175a and 175b to reduce contact resistance therebetween. Exposed portions which are not covered by the data lines 171a and 171b and the drain electrodes 175a and 175b between the source electrodes 173a and 173b, and the drain electrodes 175a and 175b exist in the semiconductors 154a and 154b.

A lower passivation layer 180p made of silicon nitride or silicon oxide is formed on the data lines 171a and 171b, the drain electrodes 175a and 175b, and the exposed portions of the semiconductors 154a and 154b.

A color filter 230 is formed on the lower passivation layer 180p. The color filter 230 may include three color filters of red, green, and blue.

At a lower portion of an overlapping portion where the color filter 230 is overlapped, a light blocking member 220 is formed on the insulation substrate 110. The light blocking member 220 may be made of a single layer or a double layer of chromium and chromium oxide or an organic material.

In the light blocking member 220 according to the exemplary embodiment of the present invention, a recessed portion 225 is formed at a location corresponding to an overlapping portion where two color filters 230a and 230b are overlapped.

The recessed portion 225 is formed throughout the overlapping portion along the overlapping portion formed from overlapping of the two color filters 230a and 230b, and the recessed portion 225 may be formed in the shape of a line so as to overlap an area of the data line 171 formed at a vertical directional edge of each pixel.

In general, as shown in FIG. 1B, two color filters 230a and 230b overlap, and thus a step difference may be formed in an upper surface compared to other portions where the color filters 230a and 230b do not overlap.

Furthermore, the light blocking member 220 is located at a lower portion of the overlapping portion of the color filter 230 and thus the step difference of the overlapping portion of the color filter 230 may be increased. In this case, the step difference generated by the overlapping portion of the color filter 230 causes a reduction of a cell gap of the liquid crystal display, and accordingly a liquid crystal alignment defect and a display quality defect may occur.

Thus, in the liquid crystal display device according to an exemplary embodiment of the present invention, the recessed portion 225 is formed in the light blocking member 220 provided in the lower portion of the overlapping portion formed by overlapping of the color filters 230 to thereby prevent generation of a step difference in the overlapping portion of the color filters 230, and accordingly reduction of the cell gap and the liquid crystal alignment defect can be prevented.

The shape of a cross-section of the recessed portion 225 of the light blocking member 220 is illustrated as a quadrangle for convenience of description, but the cross-section may have various shapes such as a triangle, a semi-circle, and the like.

The light blocking member 220 may have openings arranged in a matrix format.

An upper passivation layer 180q made of a transparent organic insulating material is formed on the color filter 230 and the light blocking member 220. The upper passivation layer 180q suppresses exposure of the color filter 230 and provides a flat surface. A plurality of contact holes 185a and 185b exposing the first and second drain electrodes 175a and 175b are formed in the upper passivation layer 180q.

A plurality of pixel electrodes 191 are formed on the upper passivation layer 180q. Each pixel electrode 191 may be made of a transparent conductive material such as ITO or IZO, or a reflective material such as aluminum, silver, chromium, or an alloy thereof.

Each pixel electrode 191 includes a first sub-pixel electrode 191a and a second sub-pixel electrode 191b that are separated from each other, each of the first and second sub-pixel electrodes 191a and 191b includes cross stem portions formed of horizontal stem portions 192 and vertical stem portions 193 crossing the horizontal stem portions 192, and minute branch portions 194 extended from the horizontal stem portion 192 and the vertical stem portion 193.

Next, the upper panel 200 will be described.

The common electrode 270 is formed on the entire surface of a transparent insulation substrate 210.

A spacer 363 is formed to maintain a space between the upper panel 200 and the lower panel 100.

Alignment layers 11 and 21 are respectively coated to inner surfaces of the lower panel 100 and the upper panel 200, and the alignment layers 11 and 21 may be vertical alignment layers. The alignment layers 11 and 21, formed of a liquid crystal alignment material such as polyamic acid, polysiloxane, and polyimide, may include at least one of generally used materials.

The alignment layers 11 and 21 may include alignment polymers formed by light-irradiating an aligning agent aid. The alignment polymer may be reactive mesogen.

A polarizer (not shown) may be provided at outer surfaces of the lower panel 100 and the upper panel 200.

The liquid crystal layer 3 is provided between the lower panel 100 and the upper panel 200. The liquid crystal layer 3 includes a plurality of liquid crystal molecules 310.

The liquid crystal molecules 310 have negative dielectric anisotropy, and are aligned so that long axes thereof are perpendicular to the surfaces of the two panels 100 and 200 while the electric field is not applied.

When voltages are applied to the pixel electrode 191 and the common electrode 270, the long axes change directions to be perpendicular to the direction of the electric field in response to the electric field formed between the pixel electrode 191 and the common electrode 270. A change degree of polarization of light passing through the liquid crystal layer 3 varies according to the tilted degree of the liquid crystal molecules 310. The change in the polarization is represented by a change in transmittance of light by a polarizer, and as a result, each pixel displays predetermined desired luminance.

The tilt direction of the liquid crystal molecules 310 is determined by the minute branch portions 194 of the pixel electrode 191, and they are tilted in a direction that is parallel with a length direction of the minute branch portion 194. Since one pixel electrode 191 includes four sub-regions in which length directions of the minute branch portions 194 are different from each other, the tilt directions of the liquid crystal molecules 310 include four directions and four domains in which alignment directions of the liquid crystal molecules 310 are different from each other are formed in the liquid crystal layer 3. Thus, a viewing angle of the liquid crystal display device can be enhanced by varying tilt directions of the liquid crystal molecules 310.

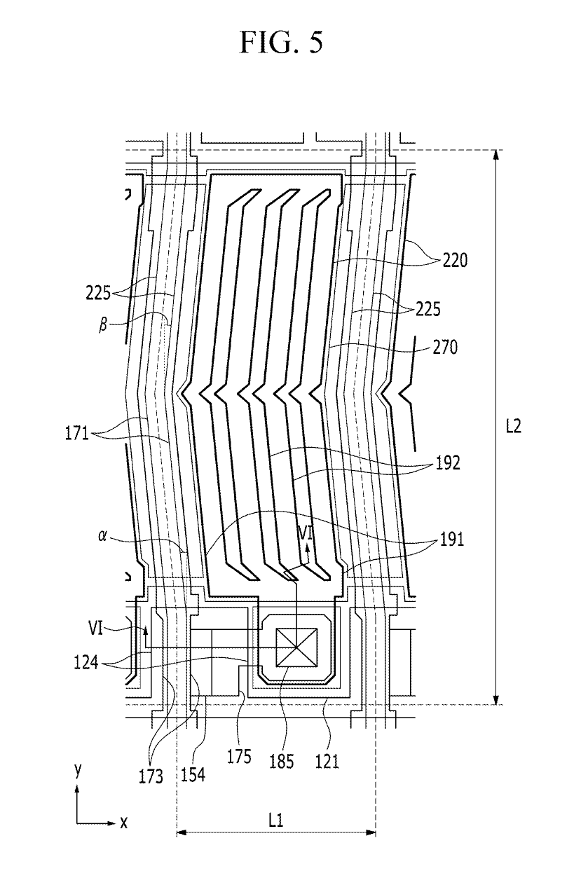

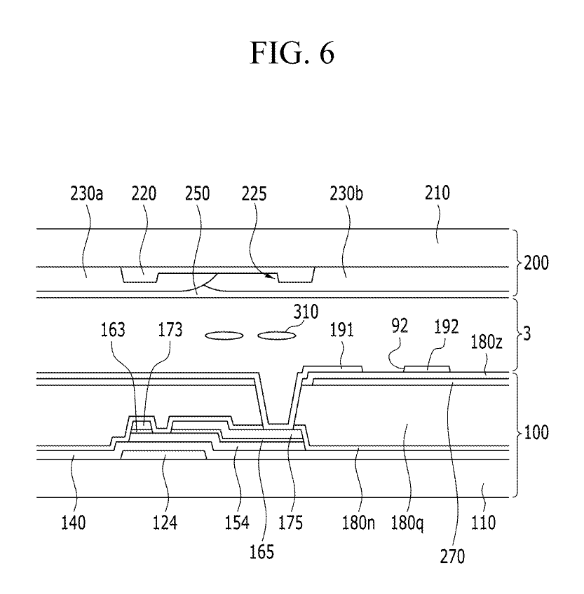

Next, referring to FIG. 5 and FIG. 6, a liquid crystal display device according to another exemplary embodiment of the present invention will be described in detail.

FIG. 5 is a pixel layout view of a liquid crystal display device according to another exemplary embodiment of the present invention, and FIG. 6 is a cross-sectional view of FIG. 5 taken along the line VI-VI.

Referring to FIG. 5 and FIG. 6, the liquid crystal display device according to the present exemplary embodiment includes a lower panel 100, an upper panel 200, and a liquid crystal layer 3 injected between the lower panel 100 and the upper panel 200. The lower panel 100 and the upper panel 200 face each other. One pixel area will be described below as an example, and the liquid crystal display device according to the exemplary embodiment of the present invention may have resolution of about 200 PPI or more. That is, about 200 or more pixels may be included in a region of about 1 inch in width and length of the liquid crystal display. In addition, a horizontal length L1 of one pixel of the liquid crystal display device according to the present exemplary embodiment may be about 40 μm or less and a vertical length L2 may be about 120 μm or less. As shown in the drawing, the horizontal length L1 of the pixel is a distance between vertical centers of two adjacent data lines 171, and the vertical length L2 of the pixel is a distance between horizontal centers of two adjacent gate lines 121.

First, the lower panel 100 will be described.

A gate conductor including a gate line 121 is positioned on a first insulation substrate 110 made of transparent glass, plastic, or the like.

The gate line 121 includes a gate electrode 124 and a wide gate pad portion (not shown) for connection with another layer or an external driving circuit. The gate line 121 may be made of an aluminum-based metal such as aluminum (Al) or an aluminum alloy, a silver-based metal such as silver (Ag) or a silver alloy, a copper-based metal such as copper (Cu) or a copper alloy, a molybdenum-based metal such as molybdenum (Mo) or a molybdenum alloy, chromium (Cr), tantalum (Ta), and titanium (Ti). However, the gate line 121 may have a multilayered structure including at least two conductive layers having different physical properties.

A gate insulating layer 140 made of a silicon nitride (SiNx), a silicon oxide (SiOx), or the like may be formed on the gate line 121 and gate electrode 124. The gate insulating layer 140 may have a multilayered structure including at least two insulating layers having different physical properties.

A semiconductor 154 made of amorphous silicon, polysilicon, or the like is formed on the gate insulating layer 140. The semiconductor 154 may include an oxide semiconductor.

Ohmic contacts 163 and 165 may be positioned on the semiconductor 154. The ohmic contacts 163 and 165 may be made of a material such as n+ hydrogenated amorphous silicon in which an n-type impurity such as phosphorus is doped at a high concentration, or a silicide. The ohmic contacts 163 and 165 may be disposed on the semiconductor 154 to form a pair. In the case where the semiconductor 154 is an oxide semiconductor, the ohmic contacts 163 and 165 may be omitted.

A data conductor including a data line 171 including a source electrode 173, and a drain electrode 175 is positioned on the ohmic contacts 163 and 165 and the gate insulating layer 140.

The data line 171 includes an end portion (not shown) for connection with another layer or an external driving circuit. The data line 171 transfers a data signal, and mainly extends in a vertical direction to cross the gate line 121.

In this case, the data line 171 may have a first curved portion with a curved shape in order to acquire maximum transmittance of the liquid crystal display, and parts of the curved portion meet each other in a middle region of the pixel area to have a V-letter shape. A second curved portion which is curved to form a predetermined angle with the first curved portion may be further included in the middle region of the pixel area.

The first curved portion of the data line 171 may be curved to form an angle α of about 7° with a vertical reference line (i.e., y, a reference line extended in a y axis direction) which forms an angle of 90° with an extending direction (i.e., x axis direction) of the gate line 121. The second curved portion disposed in the middle region of the pixel area may be further curved to form an angle β of about 7° to about 15° with the first curved portion.

The source electrode 173 is a part of the data line 171, and is disposed on the same line as the data line 171. The drain electrode 175 is formed to extend in parallel with the source electrode 173. Accordingly, the drain electrode 175 is parallel with the part of the data line 171.

The gate electrode 124, the source electrode 173, and the drain electrode 175 form one thin film transistor (TFT) together with the semiconductor 154, and a channel of the thin film transistor is formed in the semiconductor 154 between the source electrode 173 and the drain electrode 175.

The liquid crystal display device according to the exemplary embodiment of the present invention includes the source electrode 173 positioned on the same line as the data line 171 and the drain electrode 175 extending in parallel with the data line 171, and as a result, a width of the thin film transistor may be increased while an area occupied by the data conductor is not increased, thereby increasing an aperture ratio of the liquid crystal display.

The data line 171 and the drain electrode 175 may be made of a refractory metal such as molybdenum, chromium, tantalum, and titanium, or an alloy thereof, and may have a multilayered structure including a refractory metal layer (not illustrated) and a low resistance conductive layer (not illustrated). An example of the multilayered structure may include a double layer of a chromium or molybdenum (alloy) lower layer and an aluminum (alloy) upper layer, or a triple layer of a molybdenum (alloy) lower layer, an aluminum (alloy) middle layer, and a molybdenum (alloy) upper layer. However, the data line 171 and the drain electrode 175 may be made of various metals or conductors other than the metals. The width of the data line 171 may be about 3.5 μm±0.75.

A first passivation layer 180n is disposed on the data conductors 171, 173, and 175, the gate insulating layer 140, and an exposed portion of the semiconductor 154. The first passivation layer 180n may be made of an organic insulating material, an inorganic insulating material, or the like.

A second passivation layer 180q is disposed on the first passivation layer 180n. The second passivation layer 180q can be omitted. The second passivation layer 180q may be a color filter. When the second passivation layer 180q is a color filter, the second passivation layer 180q may display one of the primary colors such as three primary colors of red, green, and blue, and the primary colors may include the three primary colors of red, green, and blue, or may include yellow, cyan, and magenta. Although it is not illustrated, the color filter may further include a color filter displaying a mixed color of the primary colors or white in addition to the primary colors.

A common electrode 270 is provided on the second passivation layer 180q. The common electrode 270 has a planar shape so as to be formed on the entire surface of the substrate 110 as a whole plate, and has an opening (not illustrated) which is formed in a region corresponding to the periphery of the drain electrode 175. That is, the common electrode 270 may have a planar shape in a plane view.

Common electrodes 270 which are disposed in adjacent pixels are connected to each other so that a common voltage having a predetermined magnitude supplied from outside of the display area is transmitted thereto.

A third passivation layer 180z is provided on the common electrode 270. The third passivation layer 180z may be made of an organic insulating material or an inorganic insulating material.

A pixel electrode 191 is provided on the third passivation layer 180z. The pixel electrode 191 includes a curved edge which is substantially parallel to the first curved portion and the second curved portion of the data line 171. The pixel electrode 191 includes a plurality of first cutouts 92 and a plurality of first slit electrodes 192 defined by the plurality of first cutouts 92.

A first contact hole 185 is formed in the first passivation layer 180n, the second passivation layer 180q, and the third passivation layer 180z to expose the drain electrode 175. The pixel electrode 191 is physically and electrically connected to the drain electrode 175 through the contact hole 185 so as to be applied with the voltage from the drain electrode 175.

Although it is not illustrated, an alignment layer is coated on the pixel electrode 191 and the third passivation layer 180z, and the alignment layer may be a horizontal alignment layer rubbed in a constant direction. However, according to a liquid crystal display device according to another exemplary embodiment of the present invention, the first alignment layer includes a photoreactive material to be photo-aligned.

Next, the upper panel 200 will be described.

A plurality of color filters 230 are formed on a second substrate 210 made of transparent glass, plastic, or the like.

On the substrate 210, a light blocking member 220 is formed in a lower portion of an overlapping portion where the color filters 230a and 230b overlap. The light blocking member 220 may be made of a singular layer or a double layer including chromium and chromium oxide or an organic material.

In the light blocking member 220 according to the present exemplary embodiment, a recessed portion 225 is formed at a location corresponding to an overlapping portion where two color filters 230a and 230b overlap.

The recessed portion 225 is formed throughout the overlapping portion along the overlapping portion where the two color filters 230a and 230b overlap.

In general, the overlapping portion where the color filters 230a and 230b overlap with each other may have a step at an upper surface due to overlapping of the two color filters 230a and 230b compared to other portions where the color filters 230a and 230b do not overlap each other.

Furthermore, the light blocking member 220 is provided in a lower portion of the overlapping portion of the color filters 230a and 230b so that the step of the overlapping portion of the color filters 230a and 230b may become more significant. In this case, due to the step generated due to the overlapping portion of the color filters 230a and 230b, a cell gap of the liquid crystal display device is significantly reduced in the overlapping portion, and accordingly causing a defect in a liquid crystal alignment and a defect in display quality.

Thus, in the liquid crystal display device according to the exemplary embodiment of the present invention, the recessed portion 225 is formed in the light blocking member 220 that is disposed in a lower portion of the overlapping portion formed by being overlapped with the color filters 230a and 230b to prevent generation of a step in the overlapping portion of the color filter 230a and 230b, thereby preventing a decrease of the cell gap and a liquid crystal alignment defect.

The shape of a cross-section of the recessed portion 225 of the light blocking member 220 is illustrated as a quadrangle for convenience, but the cross-section may have various shapes such as a triangle, a semi-circle, and the like.

An overcoat 250 is formed on the color filters 230a and 230b and the light blocking member 220. The overcoat 250 corresponds to the upper passivation layer 180q in the exemplary embodiment described with reference to FIG. 3 to FIG. 4, and may be made of an (organic) insulating material. The overcoat 250 prevents exposure of the color filters 230a and 230b and provides a flat surface. The overcoat 250 can be omitted.

An alignment layer 27 may be disposed on the overcoat 250.

The liquid crystal layer 3 may include a nematic liquid crystal material having positive dielectric anisotropy.

Liquid crystal molecules 310 of the liquid crystal layer 3 are arranged such that major axes thereof are disposed parallel to the substrates 110 and 210, and have a structure in which the major axes are spirally twisted at 90° from the alignment direction of the alignment layer 11 of the lower panel 100 to the upper panel 200.

The pixel electrode 191 is applied with a data voltage from the drain electrode 175 and the common electrode 270 is applied with a common voltage with a predetermined magnitude from a common voltage applying unit which is disposed outside the display area.

The pixel electrode 191 and the common electrode 270 which are field generating electrodes generate an electric field so as to rotate the liquid crystal molecules 310 of the liquid crystal layer 3 disposed on the two electrodes 191 and 270 in a direction parallel to a direction of the electric field. The polarization of the light which passes through the liquid crystal layer 3 is varied depending on the rotational direction of the liquid crystal molecule 310 determined as described above.

In addition to the above-stated exemplary embodiment, the structure of the light blocking member 220 of the exemplary embodiments of the present invention is applicable to any liquid crystal display device having a structure in which color filters are provided in an upper substrate and a light blocking member is provided to a lower portion of an overlapping portion of color filters.

According to the exemplary embodiments of the present invention, the recessed portion is formed in the light blocking member provided in the overlapping portion of two or more color filters to reduce a step difference caused by the overlapping portion of the color filters, thereby preventing an alignment defect.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

### DESCRIPTION OF SYMBOLS

3: liquid crystal layer
310: liquid crystal molecule
100: lower panel
200: upper panel
121: gate line
140: gate insulating layer
154a, 154b: semiconductor
163a, 163b: ohmic contact
171a, 171b: data line
173a, 173b: source electrode
175a, 175b: drain electrode
230: color filter
270: common electrode
220: light blocking member
225: recessed portion
180: passivation layer
250: overcoat

What is claimed is:

1. A liquid crystal display device comprising:
a first substrate;
a first color filter and a second color filter provided on the first substrate and including an overlapping portion where at least parts of the first and second color filters overlap each other; and
a light blocking member formed between the first substrate and the overlapping portion,
wherein the light blocking member comprises a recessed portion corresponding to the overlapping portion of the first color filter and the second color filter.

2. The liquid crystal display device of claim 1, wherein a plurality of pixels are formed on the first substrate,
the plurality of pixels comprise gate lines in a row direction and data lines in a column direction, and
the recessed portion of the light blocking member is formed in an area corresponding to the data line.

3. The liquid crystal display device of claim 2, further comprising a third color filter,
wherein the overlapping portion is formed in two color filters selected from the first color filter, the second color filter, and the third color filter.

4. The liquid crystal display device of claim 3, wherein each of the first to third color filters is formed with a color selected from red, green, and blue.

5. The liquid crystal display device of claim 3, wherein the recessed portion of the light blocking member is formed in all areas that overlap the overlapping portion.

6. The liquid crystal display device of claim 3, further comprising a passivation layer provided in an upper surface of the color filters and made of an organic insulation material.

7. The liquid crystal display device of claim 6, wherein the light blocking member is made of chromium, chromium oxide, or an organic material.

8. The liquid crystal display device of claim 7, wherein the shape of a cross-section of the recessed portion is a quadrangle, a triangle, or a semi-circle.

9. The liquid crystal display device of claim 1, further comprising a field generating electrode formed on the first substrate.

10. A liquid crystal display device comprising:
a first substrate where a plurality of pixels are formed;
a second substrate facing the first substrate;
a first color filter and a second color filter provided on the second substrate and including an overlapping portion where at least parts of the first and second color filters overlap each other;
a light blocking member formed between the second substrate and the overlapping portion; and
a liquid crystal layer comprising liquid crystal molecules provided between the first substrate and the second substrate,
wherein the light blocking member comprises a recessed portion corresponding to the overlapping portion of the first color filter and the second color filter.

11. The liquid crystal display device of claim 10, wherein the plurality of pixels comprises gate lines in a column direction and data lines in a column direction, and
the recessed portion of the light blocking member is formed in an area corresponding to the data lines on the first substrate.

12. The liquid crystal display device of claim 11, further comprising a third color filter,
wherein the overlapping portion is formed in two color filters selected from the first color filter, the second color filter, and the third color filter.

13. The liquid crystal display device of claim 12, wherein each of the first to third color filters is formed with one color selected from red, green, and blue.

14. The liquid crystal display device of claim 12, wherein the recessed portion of the light blocking member is formed in all areas corresponding to the overlapping portion.

15. The liquid crystal display device of claim 12, further comprising an overcoat made of an organic insulation material on an upper surface of the color filter.

16. The liquid crystal display device of claim 15, wherein the light blocking member is made of chromium, chromium oxide, or an organic material.

17. The liquid crystal display device of claim 16, wherein the shape of a cross-section of the recessed portion is a quadrangle, a triangle, or a semi-circle.

18. The liquid crystal display device of claim 10, further comprising a field generating electrode formed on at least one of the first substrate and the second substrate.
